(19) United States
(12) Patent Application Publication
(10) Pub. No.: US 2022/0067108 A1
(43) Pub. Date: Mar. 3, 2022

(54) MICROSERVICES DATA AGGREGATION SEARCH ENGINE UPDATING

(71) Applicant: Hewlett-Packard Development Company, L.P., Spring, TX (US)

(72) Inventors: Gaurav Roy, Spring, TX (US); Sanket Anavkar, Fort Collins, CO (US); Taheri Vanwala, Pune (IN); Sandeep Gotkhindikar, Pune (IN)

(73) Assignee: Hewlett-Packard Development Company, L.P., Spring, TX (US)

(21) Appl. No.: 17/418,217

(22) PCT Filed: Apr. 27, 2019
(86) PCT No.: PCT/US2019/029520

§ 371 Date: Jun. 24, 2021

(51) Int. Cl. G06F 16/951; G06F 21/62

(52) U.S. Cl. CPC G06F 16/951; G06F 21/6227

(57) ABSTRACT

A method to update data of a data view. The data is distributed in multiple microservice databases and aggregated in a data aggregation search engine index. A user makes a request to update data of the data view. In response to the update request, an immediate data update operation is performed to update the data in one or more of the multiple microservice databases. A change queue is used to update the aggregated data in the data aggregation search engine index.

### BACKGROUND

Microservices refer to a service-oriented software design architecture in which a software application is composed of multiple processes (services) that are independently deployable. A microservices architecture improves modularity and facilitates continuous delivery and deployment. Microservices architecture can impact performance and increase runtime overhead for displaying large lists of data aggregated from multiple microservices.

### BRIEF DESCRIPTION OF THE DRAWINGS

Advantages and features of the disclosure will be rendered by reference to specific examples thereof which are illustrated in the appended drawings. The drawings illustrate only particular examples of the disclosure and therefore are not to be considered to be limiting of its scope. The principles herein are described and explained with additional specificity and detail through the use of the accompanying drawings in which:

FIG. 1 illustrates a system using a search engine to provide aggregated data from multiple microservices according to an example of the present disclosure.

FIG. 2 illustrates a process by which data of an aggregated data view is retrieved and presented to a user according to an example of the present disclosure.

FIG. 3 illustrates a process by which data of an aggregated data view is updated by a user according to an example of the present disclosure.

FIG. 4 illustrates a block diagram of a computer system architecture suitable for implementing examples of microservices data aggregation of the present disclosure, and for use in the environments described herein.

### DETAILED DESCRIPTION

Reference will now be made in detail to the examples of the disclosure, which are illustrated in the accompanying drawings. While the disclosure will be described in conjunction with the examples, it will be understood that the examples are not intended to limit the disclosure to these examples. On the contrary, the disclosure is intended to cover alternatives, modifications and equivalents which may be included within the scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure.

Systems and methods are disclosed for aggregating and presenting view data from multiple microservices. The microservice view data is aggregated in a search engine index so data retrieve operation performance is not limited by the performance of individual microservice databases. Update operations (e.g., Write/Create/Delete operations) to update the affected microservice databases are performed immediately and a change queue is implemented to update the aggregated data of the search engine index for eventual consistency.

In a microservices design pattern, each of the multiple microservices has its own database or data source containing data relevant to the particular microservice. When aggregated data from multiple sources is needed, for example in providing a device listing, there is significant latency. For some applications, lists may have multiple fields existing in multiple distinct databases of respective microservices. Providing such lists for thousands of users may result in significant latency.

Microservice data can be aggregated using a remote facade aggregation microservice. The remote fagade design pattern uses an aggregation microservice which obtains data from each of multiple microservices, aggregates the data, and provides the data in one packet to the front end. This means that the slowest microservice dictates the speed of the user interface response. This results in a significant performance impact on data retrieve operations.

Another method for aggregating microservice data is to implement an aggregation database. The aggregation database is updated along with the primary data stores (microservices databases) which results in a significant performance impact on data update operations. Moreover, maintaining immediate consistency between the primary data stores and the aggregation database increases the system architecture complexity.

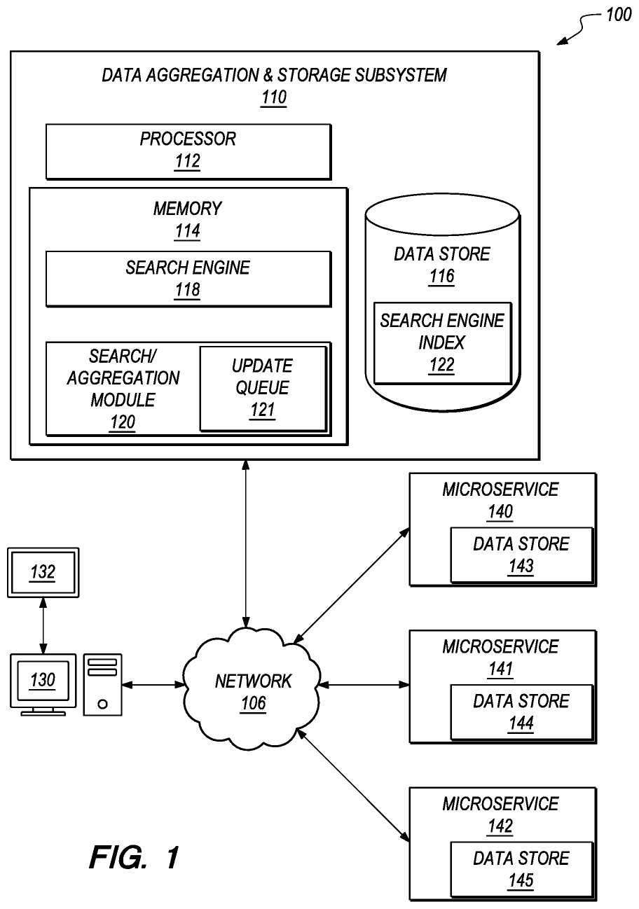

FIG. 1 illustrates a system that uses a search engine to provide aggregated data from multiple microservices according to an example of the present disclosure. System 100, shown in FIG. 1 includes a data aggregation and storage subsystem 110 to communicate with a user via a user access device 130 having a user interface 132. The user interface 132 is shown for example as web user interface (WUI) 132. The user access device 130 may be any suitable computing device, including but not limited to a desktop computing device, a laptop computing device, or a tablet computing device, among others.

System 100 also includes multiple microservices shown for example as microservices 140-142. Each microservice has an associated data store, shown for example as data stores 143-145. Although, three microservices are shown, systems employing a microservices service-oriented architecture may have many more microservices.

The data aggregation and storage subsystem 110, the user access device 130, and each of the microservices 140-142 are communicatively coupled via a network 106 (e.g., the Internet, an intranet, etc.).

As shown in FIG. 1, the data aggregation and storage subsystem 110 includes a processor 112 and a memory 114. The memory 114 includes a search engine 118 and a search/aggregation module 120. Although the search/aggregation module 120 is shown separately, the search/aggregation module 120 might be incorporated in the search engine 118. The search/aggregation module 120, which in one example may be a microservice, has an associated update queue 121.

In one example the search engine 118 may be a Lucene-based search engine, for example, Elasticsearch. For one such example, the search engine 118 provides a distributed, multi-tenant, full text engine with a web interface and schema-free JSON documents.

As shown in FIG. 1, the data aggregation and storage subsystem 110 also includes a data store 116 having a search engine index 122. The search engine index 122 may be any suitable index for generating search results. The search engine index 122 may be an inverted index. In one such example, the inverted index provides a fast data retrieval operation through full-text searches with an acceptable latency for update operations.

In one example, the search engine index 122 is prepopulated with aggregated view data having views (such as list views). The view data may be aggregated from primary data stores, which may be the separate data stores 143-145 of respective microservices 140-142. Here, indexing is used to map field values to rows or documents which provides faster searching relative to other database aggregation schemes. As shown in FIG. 1, the data store 116 may also include a cache (not shown) for storing cached search results which may be cached aggregated data comprising list views.

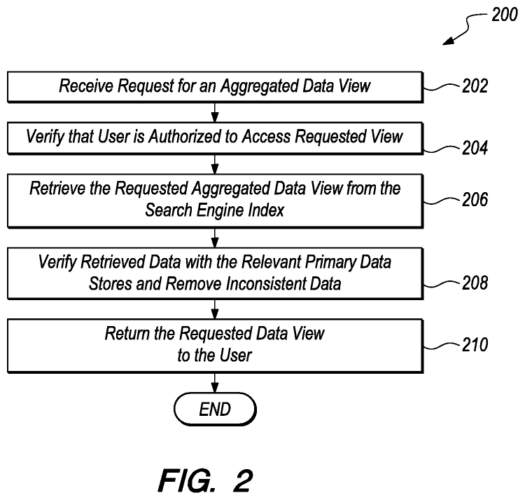

Examples of the invention aggregate data in a search engine index to leverage search engine speed for presenting views while reducing the impact of data modifications on system performance and architectural complexity. For example, when a user requests aggregated view data via WUI 132, the search/aggregation module 120 of search engine 118 searches the search engine index 122 and generates search results for the user's request. The requested view is retrieved from the search engine index and presented to the user significantly faster than in other data aggregation schemes employed in systems with service-oriented architecture. Data retrieve operations in accordance with examples of the present disclosure are discussed in more detail below in reference to FIG. 2.

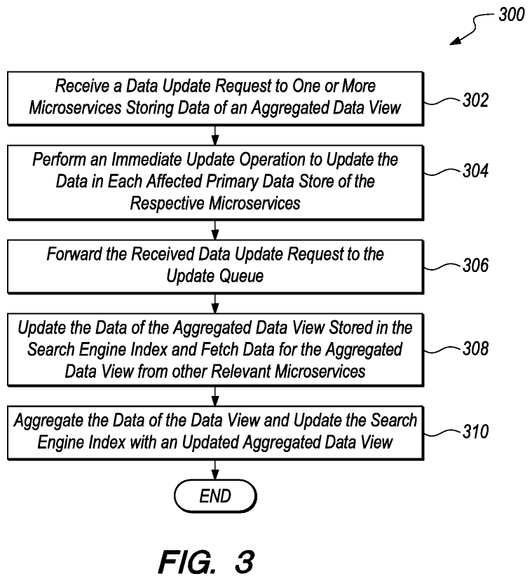

When a user updates view data, the affected view data is promptly updated in the relevant primary data stores (e.g., the affected data stores of one or more of the microservices). The update is also queued in the update queue 121. Search/aggregation module 120 eventually accesses the update queue 121 and updates the view data as directed by the user input. Search/aggregation module 120 then aggregates the updated view data and other relevant data from the microservices data stores 143-145 to create an updated aggregated data view. The updated aggregated data view is then indexed in search engine index 122. Data update operations in accordance with examples of the present disclosure are discussed in more detail below in reference to FIG. 3.

Thus, one example of the present disclosure provides for updating the data of a data view stored in the microservices databases, while asynchronously updating the data stored in the search engine index. The update operations to the data stored in the microservices databases are disassociated with the update operations to the aggregated data view data stored in the search engine index. This allows for much faster data retrieval operations with acceptable latency for data update operations. Examples of the present disclosure improve system performance in retrieving and updating aggregated data without increased system architecture complexity, particularly for data that is aggregated into large listings having multiple attributes across multiple databases that is accessed intermittently.

FIG. 2 illustrates a process by which data of an aggregated data view is retrieved and presented to a user according to an example of the present disclosure.

Process 200 of FIG. 2 begins with operation 202, in which a user request (e.g. via WUI 132 of FIG. 1) for an aggregated data view is received at a search/aggregation microservice (such as system 100 of FIG. 1). The request specifies data type and search and filter parameters.

At operation 204, a verification is performed to determine if the user is authorized to access the particular data requested (e.g., the requested aggregated data view). Unlike other database aggregation schemes in which the database contains authorization data, a search engine index is not structured to contain authorization data as search engine indexes do not provide user-wise partitioning. The verification operation verifies the user's authorization to access the requested data. In one example, the microservice performs verification of the user's authorization to access the one or more data views. In another example, the authorization verification may itself be performed outside of the microservice.

At operation 206, the requested aggregated data view is retrieved from the search engine index 122. The search/aggregation microservice searches the search engine index 122 to obtain the requested aggregated data view. In one example, user authorization verification (204) and retrieval of the requested aggregated data view (206) are performed concurrently.

At operation 208, the data comprising the aggregated data view is verified with the relevant primary data stores and any inconsistent data is removed from the search result.

At operation 210, the requested aggregated data view is returned to the WUI for presentation to the user.

Therefore, storing the aggregated data view data in the search engine index 122 allows for faster data retrieval operations. That is, the speed at which the aggregated data view is presented to the user is not limited by the data retrieval time for the individual data stores of the respective microservices as in other microservice data aggregation schemes.

FIG. 3 illustrates a process by which data of an aggregated data view is updated by a user according to the present disclosure.

Process 300, shown in FIG. 3 begins with operation 302 in which a data update request from a user via a WUI is received by a microservice. The microservice is storing data of an aggregated data view. In one example, data comprising the aggregated data is distributed in multiple microservice databases and aggregated in a data aggregation search engine.

At operation 304, an immediate update operation is performed to update the data in each of the affected data stores of the respective microservices. In FIG. 2 for example, data in data store 144 and data store 145 may be updated immediately. The user is then informed that the requested update has been performed. In one example, each of the affected microservices may notify the user that the requested data update operation has been performed. In another example, the update operation to the primary data stores is an ACID (Atomicity, Consistency, Isolation, Durability) database transaction and maintains consistency of the primary data stores. This allows efficient and effective rollbacks of the primary data stores.

At operation 306, following the data update in the primary data stores based on the user's data update request, the user's data update request is forwarded to an update queue (e.g. update queue 121 of FIG. 2) of a search/aggregation microservice. The data update request is scheduled and remains in the queue for execution. This means that the data of the aggregated data view stored in the search engine index is not immediately updated.

During this latency period, which may be, for example, 1-2 seconds, data retrieval operations of aggregated view data may still be performed as there is no read locking of the aggregated view data stored in the search engine index. Further, where the update operation is a delete operation, examples of the present disclosure perform a stale data check to prevent stale data from being presented to the user.

At operation 308, the search/aggregation microservice accesses the data update request operation in the update queue to perform the update operation requested by the user (regarding the aggregated view data of the search engine index). The search/aggregation microservice also fetches other data for the data view from the relevant microservices data stores.

At operation 310, the search/aggregation microservice aggregates the data of the data view and updates the search engine index with an updated aggregated data view. The data of the aggregated data view in the search engine index is now synchronous with the data of the primary data stores of the respective microservice. Therefore, the system provides eventual consistency. This eventual consistency is sufficient in many data retrieval and data update situations where data is accessed intermittently. So, although it takes longer to update a search engine index, the updating does not have to be immediate, and the latency is acceptable because the data is only sporadically or periodically accessed.

Methods according to the above-described examples can be implemented using computer-executable instructions that are stored or otherwise available from computer readable media. The computer executable instructions may be, for example, binaries, intermediate format instructions such as assembly language, firmware (machine readable instructions), or source code. Devices implementing methods according to the examples of the disclosure can include hardware, firmware (machine readable instructions) and/or software (machine readable instructions), and can take any of a variety of form factors.

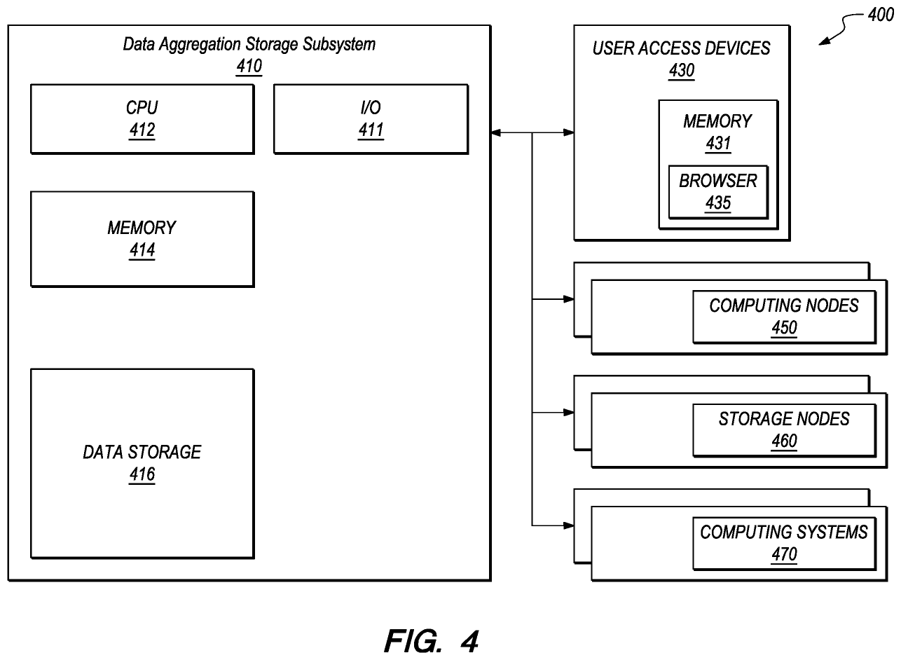

FIG. 4 illustrates a block diagram of a computer system architecture suitable for implementing examples of microservices data aggregation of the present disclosure. System 400, shown in FIG. 4 is suitable for aggregating data from one or more microservices, creating aggregated data views, storing the aggregated data views in a search engine index, and retrieving and updating the aggregated data views in accordance with examples of the present disclosure.

In particular, in FIG. 4, system 400 provides a data aggregation storage subsystem 410 that provides service to remote clients through various user access devices 430, computing nodes 450, storage nodes 460 and other computing systems 470. In the illustrated example, each computing system 470 has components that include one or more CPU/processors 412, various I/O components 411, data storage 416, and memory 414.

An example of the microservices data aggregation system is executed in memory 414, such as under control of CPU processor(s) 412 as programmed with software (machine readable instructions) of the microservices data aggregation system, and it interacts with user access devices 430, computing nodes 450 and storage nodes 460, and other computing systems 470 over a network (e.g., via the Internet and/or the World Wide Web, intranet, etc.). In this example, the system 400 includes functionality related to microservices data aggregation operations; the data aggregation storage subsystem 410 includes functionality related to managing aggregated microservices data on behalf of various users, such as, for example, in conjunction with a network-accessible microservices data aggregation service provided by system 400.

The computing systems, computing nodes and/or storage nodes as illustrated may execute various software as part of the microservices data aggregation service. For example, the user access device 430 may execute browser 435 or other software in memory 431, such as to perform and/or request microservices data aggregation operations. Such operations may affect the retrieval and/or modification of microservices aggregation data, and/or perform various other types of actions.

Various information related to the operation of the microservices data aggregation service may be stored in memory 414. Such information may include transaction data, user data, stored microservices aggregated data in various types of data structures, as well as, configuration data used to configure microservices aggregated data operations.

In some examples, the microservices data aggregation system may be implemented in firmware (machine readable instructions) and/or hardware (e.g., rather than as a means implemented in whole or in part by software instructions that configure a particular processor), including, but not limited to, one or more application-specific integrated circuits (ASICs), standard integrated circuits, controllers (e.g., microcontrollers), field-programmable gate arrays (FPGAs), complex programmable logic devices (CPLDs), etc.

Some or all of the modules, systems and data structures may also be stored (e.g., as software instructions or structured data) on non-transitory computer-readable storage mediums, such a flash drive or other non-volatile storage device. The systems, modules and data structures may also be transmitted via generated data signals on a variety of computer-readable transmission mediums, including wireless-based mediums, and may take a variety of forms.

Although a variety of examples have been described, no limitation of the claims should be implied based on particular features or arrangements in such examples. Moreover, although subject matter may have been described in language specific to examples of structural features and/or method steps, it is to be understood that the subject matter defined in the appended claims is not necessarily limited to the described features or acts.

1. A method comprising:
receiving a request to update data of a data view, the data distributed in multiple microservice databases and aggregated in a data aggregation search engine index;
performing an immediate data update operation to update the data in one or more of the multiple microservice databases; and
using a change queue to update the aggregated data in the data aggregation search engine index.

2. The method of claim 1 further comprising:
verifying an authorization of the user to access the one or more aggregated data views.

3. The method of claim 1 wherein the data is list data and the search engine is a Lucene-based search engine.

4. The method of claim 3 wherein the search engine index is an inverted index.

5. The method of claim 1 further comprising:
receiving, at a search microservice, a request from a user to retrieve aggregated data views; and
using the search engine index to retrieve the aggregated data views for display to the user.

6. The method of claim 5 further comprising:
aggregating data from a plurality of data stores to create aggregated data views and populating the data aggregation search engine index with the aggregated data views.

7. A system comprising:
a microservice, including a search engine, to receive a request from a user to access data views, the data views including data aggregated from multiple microservice databases, wherein the request to access data views is to perform an update or read operation;
a search engine index for storing the plurality of data views, wherein the data views are retrievable from the search engine index; and
wherein the microservice is to verify user authorization to access the one or more data views.

8. The system of claim 7 further comprising:
a change queue to update the aggregated data in the data aggregation search engine index.

9. The system of claim 7 wherein the search engine is an Elasticsearch search engine and the search engine index is an inverted index.

10. A non-transitory, computer-readable storage medium having stored thereon instructions, which when executed by a processor, cause the processor to perform operations comprising:
receiving at a search microservice, over a network connection from a web user interface, a request to update data of a data view, the data distributed in multiple microservice databases and aggregated in a data aggregation search engine index of a search engine;
performing an immediate, data update operation to update the data in one or more of the multiple microservice databases; and
using a change queue to update the aggregated data in the data aggregation search engine index.

11. The non-transitory, computer-readable storage medium of claim 10 wherein the search engine is a Lucene-based search engine and the data aggregation search engine index is an inverted index.

12. The non-transitory, computer-readable storage medium of claim 10 wherein the search engine index is prepopulated with the aggregated data views.

13. The non-transitory, computer-readable storage medium of claim 10 wherein the operations further comprise:
receiving at the search microservice a request from a user to retrieve one or more of the aggregated data views;
retrieving the one or more aggregated data views from the search engine index using the search engine; and
providing the one or more aggregated data views to the user.

14. The non-transitory, computer-readable storage medium of claim 13 wherein the operations further comprise:
verifying an authorization of the user to access the one or more aggregated data views.

15. The non-transitory, computer-readable storage medium of claim 14 wherein the operation of retrieving the one or more aggregated data views from the search engine index and the operation of verifying an authorization of the user to access the one or more aggregated data views are performed concurrently.
